(19) United States
(12) Patent Application Publication
(10) Pub. No.: US 2007/0057808 A1
(43) Pub. Date: Mar. 15, 2007

(54) System for controlling source devices and playback devices

(75) Inventor: Martin Knespel, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,828

(22) PCT Filed: Sep. 14, 2004
(86) PCT No.: PCT/IB04/51753

§ 371 Date: Mar. 15, 2006

(30) Foreign Application Priority Data
Sep. 17, 2003 (EP) 03 103 420.0

(51) Int. Cl. G08C 19/00

(52) U.S. Cl. 340/825.69

(57) ABSTRACT

In a system (2) having at least one control device (3, 4) for controlling at least one source device (PC, DVD, RADIO, MP3, TV1, TV2) and one playback device (B1, B2, TV1, TV2, M) of the system (2) that are connected with one another via a network, the control device (3, 4) is constructed to activate an active data link (D) that connects a source device (PC, DVD, RADIO, MP3, TV1, TV2) and at least one playback device (B1, B2, TV1, TV2, M), wherein all control commands (SB) entered with the control device (3, 4) relate to the devices (PC, DVD, RADIO, MP3, TV1, TV2, B1, B2, TV1, TV2, M) connected via the active data link (D).

The invention relates to a system having at least one control device for controlling at least one source device and one playback device of the system, which are connected with one another via a network.

The invention relates further to a method for controlling at least one source device and one playback device by means of at least one control device, the source device and the playback device being connected with one another via a network.

Such a system and such a method are known from the document WO 00/77759. The control device disclosed therein is formed by a remote control that is designed to control a plurality of devices (DVD-player, VCR, CD-player). For example, the DVD-player and the VCR here form source devices and the TV forms a playback device, which are connected with one another via an IEEE 1394 data link. The remote control comprises a keypad, which forms input means and with which a user is able to enter a control command by operating a key. Such a control command can be, for example, the control command “PLAY”, in order to put the DVD-player into playback mode. To do this, the user operates a key to specify that the following control command is intended for the DVD-player, and subsequently the key allocated to the “PLAY” control command, which key thereupon emits input information identifying the key. By this means, the cable connection from the DVD-player via the VCR to the TV is established as active data link and the film being played by the DVD-player is played back with the TV.

In the case of the known system and the known method, it has proved a disadvantage that with each control command for the source device or the playback device of the active data link, the device for which the control command is intended has to be identified.

It is an object of the invention to produce a system corresponding to the type specified in the first paragraph and a method corresponding to the type specified in the second paragraph, with which a simpler operation of the devices is rendered possible. To achieve the above-specified object, such a system has the following features:

System having at least one control device for controlling at least one source device and one playback device of the system, which are connected with one another via a network, wherein the at least one source device is designed to supply information stored or received with the source device to an active data link and wherein the at least one playback device is designed for audio and/or visual playback of the information that is supplied by the source device via the active data link to the playback device, and wherein a source device and at least one playback device are activatable by means of the control device to establish the active data link and wherein all control commands subsequently supplied by the control device relate to active source and playback devices connected via the active data link.

To achieve the above-specified object, in such a method the following steps are executed:

Method of controlling at least one source device and one playback device by means of at least one control device, wherein the source device and the playback device are connected with one another via a network and the following method steps are executed: supplying information stored in or received by the source device to an active data link;

audio and/or visual playback of the information received via the active data link with the playback device;

establishing the active data link between a source device and at least one playback device, wherein all control commands subsequently supplied by the control device relate to active source and playback devices connected via the active data link.

Through the features according to the invention, the control commands of the control device always relate to the active source device and to the one or more active playback devices of the data link activated by the control device. A “PLAY”, “STOP”, “FORWARD”, . . . control command therefore always relates clearly to the one active source device of the active data link and a “VOLUME UP”, “MUTE”, . . . control command relates automatically to all active playback devices of the active data link. The user therefore does not have to switch between the individual devices on the remote control, wherein by means of a control device just one data link can be activated and subsequently the devices activated with the activated data link can be controlled.

In accordance with the features of claim 2, the advantage is obtained that to activate a data link, all playback devices not currently being used display or acoustically reproduce a selection list, from which, in accordance with claim 3, one or more playback devices and a source device can be selected for the active data link.

In accordance with the features of claim 4, the advantage is obtained that at any time the user is able to switch from playback of the film played back with the DVD-player in his bedroom on the TV in the living room to playback on the TV in the children's room.

In accordance with the features of claim 5, the advantage is obtained that the selection list can be displayed and/or acoustically reproduced with the control device.

In accordance with the features of claim 6, the advantage is obtained that the control device transmits no special manufacturer-dependent control code for each control command to the devices, but rather the control command in the form of text can be interpreted independently of manufacturer and can be carried out in the devices.

In accordance with the features of claim 7, the advantage is obtained that, for example, each family member can have his own remote control and can set up his own active data link.

In accordance with the features of claim 8, the advantage is obtained that the source and playback devices can be personalized for the user, since the user is clearly identified by his remote control. In this case, for example, the user interface, and for example also the transmitter allocation in the case of a television set, can be adapted to the wishes of the particular user.

These and other aspects of the invention are apparent from and will be elucidated with reference to the embodiment described hereinafter, to which the invention is not restricted however.

In the drawings:

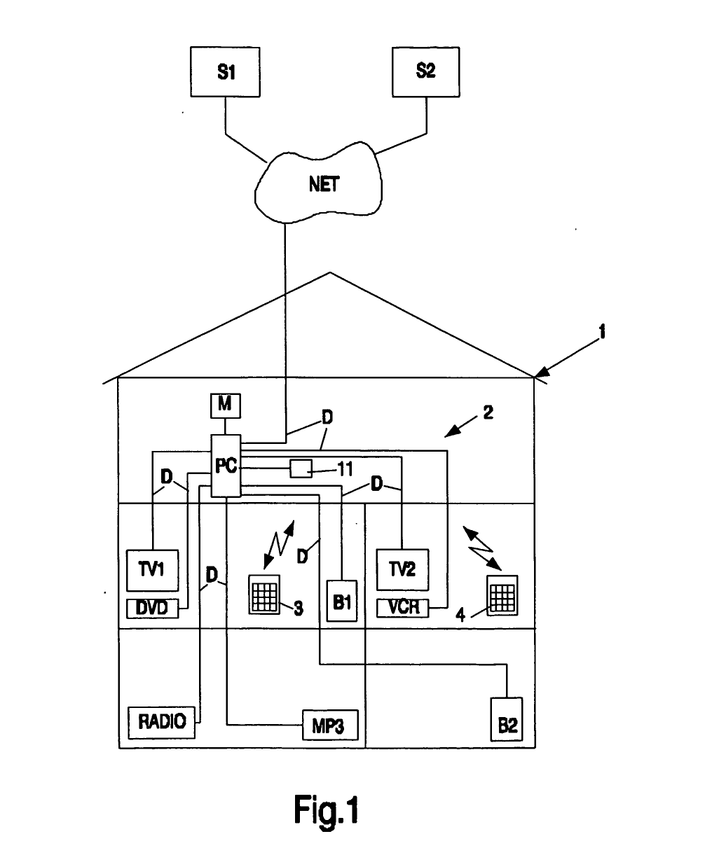

FIG. 1 shows a system having several devices that are controlled by a first remote control and a second remote control, each of which forms a control device.

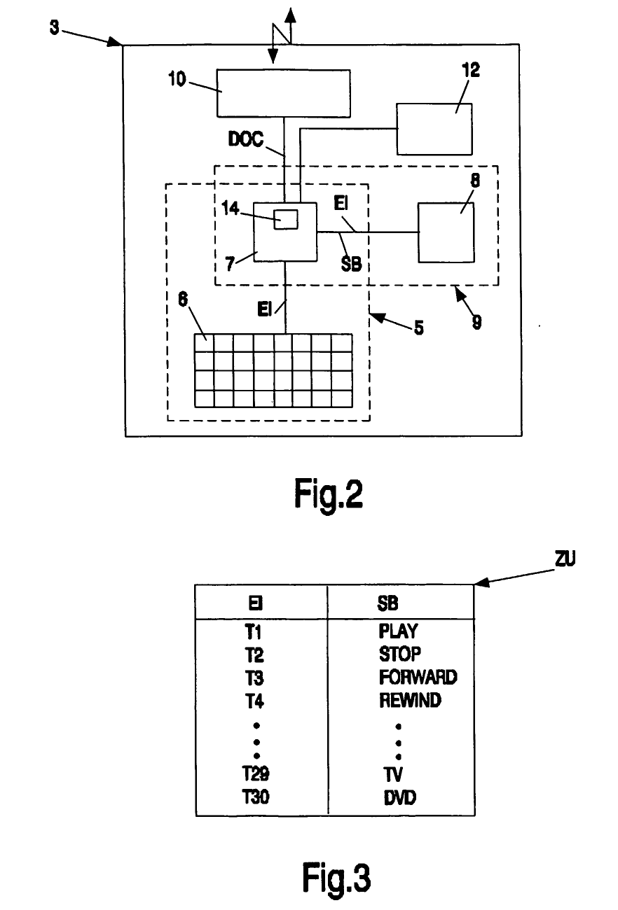

FIG. 2 shows the first remote control according to FIG. 1,

FIG. 3 shows an allocation table stored in memory means of the first remote control, which table stores input information and control commands allocated to one another.

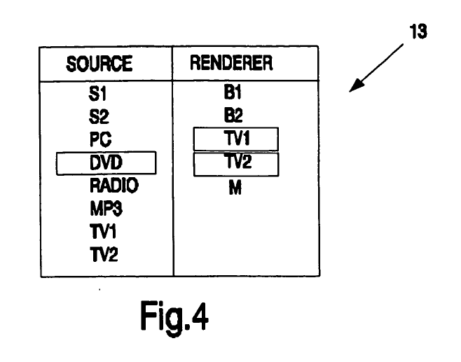

FIG. 4 shows a link table for display with a display of the first remote control, which table lists source devices and playback devices activatable for a data link.

FIG. 1 shows schematically a house 1 in which a system 2 having a first remote control 3 and a second remote control 4 is provided, the remote controls 3 and 4 forming control devices and being provided for control of a plurality of source devices and playback devices in the house 1. A source device or source shall be understood here to mean a computer PC, a DVD-player DVD, a radio RADIO, an MP3-player MP3 as well as a first television set TV1 and a second television set TV2. A source device serves as information source and outputs information (audio, video or data) via data links D to playback devices. Furthermore, the computer PC is connected to the internet NET and is designed to receive, via the internet NET, information from a first server S1 and a second server S2, which also form source devices of the system 1.

An audio speaker box pair B1, an audio speaker box pair B2, the first television set TV1, the second television set TV2 and the monitor M are to be understood here as playback device or renderer. A playback device is designed for audio and/or visual playback of information that is supplied from the source device via the active data link D to the playback device.

A respective active data link D can be established by means of the first remote control 3 and the second remote control 4, an active data link D connecting a source device that is active for that purpose and one or more playback devices. As soon as an active data link D has been established with the first remote control 3 or the second remote control 4, all further control commands SB relate exclusively to the active source device and playback devices connected with the respective active data link D. To make this possible, each remote control 3 and 4 is distinguished by identification information KI, which clearly identifies the remote control 3 or 4.

This produces the advantage that a “PLAY”, “STOP”, “FORWARD, . . . control command SB always relates clearly to the active source device of the active data link and a “VOLUME UP”, “MUTE”, . . . control command SB always relates to all active playback devices of the active data link D. The user therefore does not have to use the remote control to switch between the individual devices, wherein by means of one control device in each case only one data link D can be activated and subsequently the devices activated with the activated data link D can be controlled. This will be described in further detail with reference to exemplary embodiments.

The first remote control 3, which is of identical construction with the second remote control 4, is illustrated detail in FIG. 2. The first remote control 3 comprises input means 5, which are formed by a keypad 6 and a keypad readout program executed by a processor 7 of the first remote control 3. Each key of the keypad 6 is assigned a key code, which forms input information EI. When a user of the first remote control 3 operates, for example, the key T1 labeled “PLAY” in order to activate the playback operating mode in a source device, then the associated key information T1 is supplied as input information EI to the processor 7 and processed by the keypad readout program.

FIG. 3 illustrates an allocation table ZU, in which the input information EI is allocated to the control commands SB. The first remote control 3 comprises memory means 8 in which the allocation table ZU is stored. Processing means 9 of the first remote control 3 are formed by different programs (display activation program, encoding program, . . . ) executed by the processor 7 and by the memory means 8. The processing means 9 are constructed inter alia to encode the entered input information EI and to output transmission information to transmission means 10.

The transmission means 10 are constructed for contactless communication of the transmission information in accordance with the known transmission method WLAN (Wireless Local Area Network Standard WiFi, IEEE 802.11 a/b/g). According to the WLAN transmission method, a radio-frequency transmission is used, in which the transmission information sent with the transmission means 10 can be received throughout the house 1. Transmission means 11 corresponding to the transmission means 10 are connected to the computer PC and are designed to communicate with the transmission means 10.

The first remote control additionally comprises a display 12, with which inter alia a link table 13 shown in FIG. 4 can be displayed. The link table 13 lists all source devices and playback devices that are currently being passively controlled and consequently currently not linked into an active data link D. Further details of this are given from the following examples of application.

The processing means 9 now additionally comprise command-encoding means 14 for encoding the entered input information EI in accordance with a command-encoding method independent of the transmission method WLAN, a command document DOC being determined as transmission information and containing, in the form of text editable with a text editor, a control command SB allocated to the entered input information EI. The command document DOC is here formed by a so-called XML-document (Extended Markup Language). XML-documents are today already being used for the transmission of audio and video information from source devices to playback devices and are known to the expert in this context.

According to the invention, an XML-document for controlling source devices and playback devices is created in the first remote control 3 and subsequently transmitted with the transmission means, the XML-document containing the control command SB to be transmitted in the form of text editable with a text editor. It is especially advantageous here for the encoding of the control command SB in an XML-document to be independent of the chosen transmission method. The XML-document can thus be effected according to the WLAN transmission method, but also, for example, according to an infrared transmission method, a transmission method according to IEEE 1394 or a transmission method by way of a USB-data bus. In contrast thereto, the transmission of a “PLAY” control command SB with a conventional infrared remote control is dependent on the transmission method and the control command “PLAY” has to be decoded in the infrared receiver and encoded according to, for example, the IEEE 1394 command code if the “PLAY” control command is to be transferred onwards via a IEEE 1394 data bus.

According to the invention, the advantage is also obtained that the control command SB is contained in the form of text in the XML-document and that this text (e.g. PLAY or CHANNEL UP) is customary for control commands in the case of virtually all manufacturers and customers—like a standard—and can consequently be interpreted, spanning manufacturers, in all source devices and playback devices. Changing a control command SB assigned to a key or changing several control commands SB assigned to a key is therefore especially easy, as explained in detail in the following from the examples of application.

According to a first example of application, it is now assumed that a first user has set up with his remote control, the first remote control 3, an active data link D from the DVD-player DVD as source device via the computer PC to the second television set TV2 as playback device, and is watching a film. It is assumed further that a second user, who has the second remote control 4, wishes to play a film with the video recorder VCR and watch it on the first television set TV1. To do this, the second user operates a key of the second remote control to set up a further active data link D.

From the computer PC the second remote control 4 receives via the transmission means 11 and 10 the information that the DVD-player DVD and the second television set TV2 are already linked into an active data link D and which of the source devices and playback devices connected to the network are still passive and therefore available for the further active data link. The processing means 9 hereupon display the link table 13 on the display, the entries DVD and TV2 not being displayed for selection. The second user then selects the video recorder VCR as source device or source and the first television set TV1 as playback device or renderer. Corresponding information is transmitted to the computer PC, whereupon the video recorder VCR and the first television set TV1 are activated and a further active data link D is set up between these devices. This further data link D is associated with the second remote control 4 and can be deactivated again or changed only by this. This produces the advantage that inputs of the first user with the first remote control 3 do not disturb the second user as he watches the film being played on the first television set TV1.

All control commands SB input by the second user with the second remote control 4 that are relevant to source devices (e.g. PLAY, NEXT, STOP, FORWARD, . . . ) are now transmitted by the second remote control 4 identified for the video recorder VCR. Likewise, all control commands SB input by the second user with the second remote control 4 that are relevant to playback devices (e.g. VOLUME UP, CHANNEL UP, BRIGHTNESS UP, . . . ) are transmitted by the second remote control 4 identified for the first television set TV1. This produces the advantage that the user does not have to operate any additional keys to identify the device for which a control command SB is entered.

The clear allocation of the second remote control 4 to the further active data link D also produces the advantage that a plurality of so-called personalization features are rendered possible, without the user having to identify himself by entering a code assigned to him. One personalization feature that can be provided is, for example, that a specific menu control preferred by the second user is displayed with a specific background color, text color and menu navigation with the first television set TV1. Likewise, the films recorded for the second user with the video recorder VCR and filed in an archive system could be displayed directly. In this connection, the expert is familiar with a number of further possible personalization features.

If the second user now enters the control command “PLAY” by operating the key T1, then the command-encoding means 14 are constructed to create the following XML-document as command document DOC or transmission information, which contains the control command “PLAY” as text editable with a text editor.

<?xml version=“1.0” encoding=“iso-8859-1” standalone=“no” ?>
<!DOCTYPE XML_Remote SYSTEM “XML_Remote.dtd”>
<RC>
<device type=“VCR” />
<command type=“PLAY” />
</RC>

In the above XML-document, the video recorder VCR is thus identified as source device by choice information A1=VCR, for which the control command SB “PLAY” that follows in the XML-document is provided. It is now especially advantageous that the control command SB “PLAY” can be decoded independently of the manufacturer of the video recorder VCR and evaluated for activation of the playback operation mode, since the word “PLAY” is the common expression for this.

The opportunity now to adapt the first remote control 3 to the wishes of the first user is especially advantageous. For that purpose, by means of the transmission means 10 and 11 the user can transmit the XML-document created by the command-encoding means 14 for each key of the first remote control 3 to the computer PC, and edit it with a text editor. The user can here, for example, assign the control command “REWIND” to the key T1 by replacing the text “PLAY” in the XML-document by the text “REWIND” and storing the edited XML-document in the memory means 8 by means of the transmission means 10 and 11. Alternatively, however, it may be that a complete XML-document belonging to each key of the remote control 3 has already been stored.

Likewise, it is possible to accommodate two or more control commands SB in an XML-document. For example, the key T5 could be occupied with the combination of control commands for selecting the input for satellite receivers and for recording on a video recorder. A corresponding XML-document could appear as follows:

<RC>
<device type=“DVD” />
<command type=“PLAY” />
<device type=“VCR” />
<command type=“RECORD” />
</RC>

The corresponding XML-document could alternatively appear as follows:

<RC>
<command>
<device type=“DVD” />
PLAY
</command>
<command>
<device type=“VCR” />
RECORD
</command>
</RC>

The user is therefore able to adapt his remote control to his requirements especially easily and, for example, switch off all appliances at once. Likewise, a control command could be inserted in the XML-document in several languages or in several ways in order to allow decoding in a wide variety of devices. For example, both the control command “PLAY” and the control command “WIEDERGABE” could be inserted in the XML-document for activation of the playback operating mode in a playback device.

According to a further example of application, it is assumed that the second remote control 4 has no display, for which reason the link table 13 for determining the active data link D is shown with currently passive playback devices. It is further assumed that the first user has set up with the first remote control 3 an active data link D between the computer PC as source device and the first television set TV1 as playback device. When the second user with the second remote control 4 operates a key to set up the further active data link D, then the link table 13 is displayed with the second television set TV2 and the monitor M. Regardless of whether the second user is at that moment in front of the monitor M or the second television set TV2, he can now select the desired source device and playback device, whereupon the playback devices not selected are set to the passive state again. It is especially advantageous here that the first user is not disturbed as he watches his film.

To allow the user to make a choice, the first speaker box pair B1 and the second speaker box pair B2 as playback devices could reproduce the link table 13 acoustically. Likewise, the second remote control 4 could have a built-in loudspeaker for acoustic reproduction of the link table 13.

The first user can additionally activate a further playback device at any time to the data link D he has activated, or can deactivate an already active playback device. He will do this, for example, when he does not want to finish watching the film with the first television set TV1 but wants to switch to the second television set TV2.

It should be mentioned that each of the source devices and playback devices of the system 2 or even just some source devices and playback devices of the system 2 could also have transmission means for transmission of transmission data according to the WLAN transmission method or comparable transmission methods. By virtue of the identification information KI of the first remote control 3 or the second remote control 4 co-transmitted in the XML-document DOC and by virtue of the choice information AI co-transmitted in the XML-document DOC, which information identifies the device for which the control command SB is intended, each of the devices is able to process the received XML-document DOC correspondingly.

It should be mentioned that the complete XML-document DOC allocated to the control command SB or the input information EI can be stored in the memory means 8. In that case, however, it would not be possible for choice information AI to be contained in the XML-document DOC. It is likewise possible, as described above, for the command-encoding means 14 to assemble and hence encode the XML-document for a specific key T only after the key has been operated.

It should be mentioned that the transmission means 11 are provided as transmission means of all devices (source devices and playback devices) illustrated in FIG. 1. Consequently, the transmission means 11 could contain command-encoding means that decode the command document DOC for all devices and supply correspondingly addressed control commands SB to the respective device. On the other hand, each device could also have command-decoding means.

It should be mentioned that a plurality of independent active data links could also be set up with one control device, in order to control a plurality of devices activated to these active data links. In that case, however, the user would have to select in each case the active data link for which the control command is entered.

1. A system (2) having at least one control device (3, 4) for controlling at least one source device (PC, DVD, RADIO, MP3, TV1, TV2) and one playback device (B1, B2, TV1, TV2, M) of the system (2) that are connected with one another via a network, wherein the at least one source device (PC, DVD, RADIO, MP3, TV1, TV2) is constructed to supply information stored or received with the source device (PC, DVD, RADIO, MP3, TV1, TV2) to an active data link (D) and wherein the at least one playback device (B1, B2, TV1, TV2, M) is constructed for audio and/or visual playback of the information that is supplied by the source device (PC, DVD, RADIO, MP3, TV1, TV2) via the active data link (D) to the playback device (B1, B2, TV1, TV2, M), and wherein a source device (PC, DVD, RADIO, MP3, TV1, TV2) and at least one playback device (B1, B2, TV1, TV2, M) are activatable by means of the control device (3, 4) to establish the active data link (D) and wherein all control commands (SB) subsequently supplied by the control device (3, 4) relate to active source and playback devices connected via the active data link (D).

2. A system (2) as claimed in claim 1, wherein the control device (3, 4) for activating the at least one playback device (B1, B2, TV1, TV2, M) and source device (PC, DVD, RADIO, MP3, TV1, TV2) for the active data link (D) is constructed to activate at least the passive playback devices (B1, B2, TV1, TV2, M) and source devices (PC, DVD, RADIO, MP3, TV1, TV2) presently not linked into active data links (D), in order to reproduce acoustically and/or visually a selection list (13) of the playback devices (B1, B2, TV1, TV2, M) and/or source devices (PC, DVD, RADIO, MP3, TV1, TV2) activatable for the active data link (D).

3. A system (2) as claimed in claim 2, wherein by means of the control device (3, 4) one or more of the playback devices (B1, B2, TV1, TV2, M) listed in the selection list (13) and one of the source devices (PC, DVD, RADIO, MP3, TV1, TV2) listed in the selection list (13) are activatable for the active data link (D).

4. A system (2) as claimed in one of the claims 2 or 3, wherein by means of the control device (3, 4) playback devices (B1, B2, TV1, TV2, M) activated for the active data link (D) can be deactivated and other playback devices (B1, B2, TV1, TV2, M) can be activated.

5. A system (2) as claimed in claim 1, wherein the control device (3, 4) for activating the at least one playback device (B1, B2, TV1, TV2, M) and source device (PC, DVD, RADIO, MP3, TV1, TV2) for the active data link (D) is constructed for audio and/or visual reproduction of a selection list (13) of the playback devices (B1, B2, TV1, TV2, M) and source devices (PC, DVD, RADIO, MP3, TV1, TV2) activatable for the active data link (D).

6. A system (2) as claimed in claim 1, wherein for supply of control commands (SB) the control device (3, 4) supplies a command document (DOC), which command document (DOC) contains at least the control command (SB) in the form of text.

7. A system (2) as claimed in claim 1, wherein at least two control devices (3, 4) are usable in the system, each control device (3, 4) being identified by identification information (KI) identifying it.

8. A system (2) as claimed in claim 7, wherein at least the user interface of the active source device (PC, DVD, RADIO, MP3, TV1, TV2) and/or of the active playback device (B1, B2, TV1, TV2, M) of an active data link (D) are dependent on the identification information (KI) of the control device (3, 4) by which the active data link (D) was set up.

9. A method for controlling at least one source device (PC, DVD, RADIO, MP3, TV1, TV2) and a playback device (B1, B2, TV1, TV2, M) by means of at least one control device (3, 4), the source device (PC, DVD, RADIO, MP3, TV1, TV2) and the playback device (B1, B2, TV1, TV2, M) being connected with one another via a network, and the following method steps being executed:
supplying information stored in or received with the source device (PC, DVD, RADIO, MP3, TV1, TV2) to an active data link;
audio and/or visual playback of the information received via the active data link (D) with the playback device (B1, B2, TV1, TV2, M);
establishing the active data link (D) between a source device (PC, DVD, RADIO, MP3, TV1, TV2) and at least one playback device (B1, B2, TV1, TV2, M), wherein all control commands (SB) subsequently supplied by the control device (3, 4) relate to active source and playback devices (B1, B2, TV1, TV2, M) connected via the active data link (D).

10. A method as claimed in claim 9, wherein the control means (3, 4) for activating the at least one playback device (B1, B2, TV1, TV2, M) and source device (PC, DVD, RADIO, MP3, TV1, TV2) for the active data link (D) activates the passive playback devices (B1, B2, TV1, TV2, M) and source devices (PC, DVD, RADIO, MP3, TV1, TV2) presently not in active data links (D) and reproduces acoustically and/or visually a selection list (13) of the playback devices (B1, B2, TV1, TV2, M) and/or source devices (PC, DVD, RADIO, MP3, TV1, TV2) activatable for the active data link (D).
